(19) United States
(12) Patent Application Publication
(10) Pub. No.: US 2018/0124059 A1
(43) Pub. Date: May 3, 2018

(54) Device authentication of aircrew mobile devices on board aircraft

(71) Applicants: Airbus Operations GmbH, Hamburg (DE); Airbus Defence and Space GmbH, Taufkirchen (DE)

(72) Inventors: Martin KUBISCH, Muenchen (DE); Timo WARNS, Hamburg (DE); Michael NETZLER, Hamburg (DE)

(21) Appl. No.: 15/783,089

(22) Filed: Oct. 13, 2017

(30) Foreign Application Priority Data
Oct. 13, 2016 (EP) 16193655.4

(51) Int. Cl. H04L 29/06; H04W 12/06; H04W 12/08; H04L 29/08

(52) U.S. Cl. CPC H04L 63/102; H04W 12/06; H04L 67/12; H04W 76/02; H04W 12/08

(57) ABSTRACT

Configurations of security settings of an access point arranged on board an aircraft. An exemplary embodiment of a method for configuring security settings of an access point arranged on board an aircraft for the authentication of mobile terminals comprises: receipt of flight-related security data from a mobile terminal via a configuration interface of the access point; and configuring of security settings of the access point in a configuration mode based on the flight-related security data so that automatic authentication of preconfigured mobile terminals for access to the access point is possible.

### CROSS-REFERENCES TO RELATED APPLICATIONS

This application claims the benefit of the European patent application No. 16193655.4 filed on Oct. 13, 2016, the entire disclosures of which are incorporated herein by way of reference.

### BACKGROUND OF THE INVENTION

The invention relates generally to the configurations of security settings of an access point arranged on board an aircraft. In particular, the invention relates to methods for configuring security settings of the access point, a method for preparing the configuration of the security settings of the access point, such an access point, a mobile terminal for preparing the configuration of the security settings of the access point and a system comprising the access point and at least one such mobile terminal.

Cabin functions on board an aircraft are now controlled by means of special operating units arranged on board an aircraft. Such operating units are mostly connected hard-wired to the cabin components to be controlled, such as the cabin lights, loudspeakers and other cabin components. The control of the cabin functions is reliably enabled via the hard-wiring. A growing demand exists to assume cabin component control tasks with the aid of wireless terminals such as mobile phones and tablets. The elimination of the wiring leads to a reduction in the work effort of the cabin aircrew. On the other hand, control by means of mobile terminals enhances the user friendliness and the service experience of the passengers due to the more direct reaction capability of the cabin aircrew. This is because each member of the aircraft crew can carry their own device with them and use it to control a wide variety of cabin functions as well as to receive messages, warnings and alarms of the cabin management system promptly, for example. However, it is important that only certain mobile terminals may be permitted to control cabin components. The requirement therefore exists for an authentication of the terminals before the control process.

For wireless fidelity, Wi-Fi, various known authentication methods are available, namely the so-called Wi-Fi Protected Access 2, WPA2, Personal and the so-called WPA2 Enterprise. WPA2 Personal does not need any additional network service for security but requires the execution of manual actions on each client terminal in the case of a first connection or changing login details. This is detrimental to user friendliness. WPA2 Enterprise requires a central server to distribute all required security data to all associated access points within a network. Although this facilitates centralized management of device authentication and device authorization for attaining the highest possible security and user friendliness, since the terminal user does not have to carry out any manual operations to connect to the network, the aircrew carrying the mobile terminals usually moves from one aircraft to another between different flights. This necessitates the central server lying outside the aircraft having to have a direct connection to all onboard access points of the entire fleet of the airline. Since such a direct connection to all onboard access points cannot be guaranteed and is not intended either, the applicability of WPA2 Enterprise for the application of authentication of mobile terminals on different aircraft is not practical.

The need therefore exists for methods and devices which permit an authentication of mobile terminals on board aircraft in a user-friendly and reliable manner

### SUMMARY OF THE INVENTION

According to a first aspect of the invention, a method is provided for configuring security settings of an access point arranged on board an aircraft for the authentication of mobile terminals. Expressed another way, the security settings are used for authenticating mobile terminals. The method comprises the receipt of flight-related security data from a mobile terminal via a configuration interface of the access point. The method further comprises a configuration of security settings of the access point in a configuration mode based on the flight-related security data so that automatic authentication of preconfigured mobile terminals for access to the access point is possible. Expressed another way, the security settings of the access point can be configured by means of the flight-related security data in such a way that preconfigured mobile terminals can be checked for their access right to the access point.

The method according to the first aspect relates to steps which are carried out in the access point or from the perspective of the access point.

The access point is configured by this in a secure manner without a connection having to exist between a central security data server and the access point. Furthermore, the method is user-friendly, as no manual step by the user is necessary.

The mobile terminal from which the access point receives the flight-related security data can be a mobile terminal of a master user, such as, e.g., the purser responsible for the corresponding flight. The mobile terminal can also be termed mobile master terminal accordingly. The preconfigured mobile terminals that can be authenticated can be, apart from the mobile terminal of the master user, mobile terminals of normal users, such as, e.g., mobile terminals of the aircrew of the upcoming flight. These mobile terminals can be termed mobile normal terminals accordingly. The basic design of the mobile normal terminals and the mobile master terminal can at least be similar The mobile normal terminals can be, or can become, preconfigured differently from the mobile master terminal, so that, e.g., only the mobile master terminal can connect to the access point via its configuration interface in the configuration mode described in greater detail later, but the mobile normal terminals cannot.

The terms “authenticate” and “authentication” can be used here both for the process of verifying authorization and for the result of this verification. The flight-related security data can be security data specific to a certain flight, i.e., flight-specific, such as, e.g., security data only valid for a certain flight. In the latter case, the security data would no longer be valid for another flight or another aircraft. Purely as an example, the security data can comprise a network name and/or a network key. Furthermore, the security data can comprise information regarding the validity/invalidity of certificates.

The method can also comprise automatic authentication of preconfigured mobile terminals, which are located in the service area of the access point, for access to the access point. For example, the authentication can run positively, i.e., it can be affirmed for all the mobile terminals in the service area which are preconfigured so that the flight-related security data is known to them or the flight-related security data is stored in these. It is conceivable, for example, that the relevant flight-related security data was transmitted previously to the mobile terminals or that the flight-related security data was filed previously in the mobile terminals. The mobile terminals that are located in the service area of the access point but are not preconfigured, such as, e.g., knowing the flight-related security data, cannot be successfully authenticated.

The method can further comprise automatic authorization of preconfigured mobile terminals, which are located in the service area of the access point, for access to the access point. Authorization in the broadest sense is consent, in particular the granting of rights. For logical reasons, the authorization does not take place without prior successful authentication. Information technology terms authorization the initial assignment and repeatedly initial verification by special methods of access rights to data and to services with regard to interested system users. In particular, authorize or authorization can be understood here as, e.g., the permitted access to the control of one or more components, devices and/or units of the aircraft cabin.

For example, the method can further comprise receiving of a trigger signal/activation signal via a secure communications channel at the access point. The secure communications channel can be formed as a hard-wired connection between a component or unit in the cabin of the aircraft and the access point. Alternatively, the secure communications channel can be realized by so-called out-of-band systems, i.e., by communications systems whose radio channels operate using frequency ranges that lie outside the normal or usual radio frequency ranges. Regardless of the exact realization of the secure communications channel, the communications channel cannot be tapped from outside. On receipt of the trigger signal/activation signal the configuration interface can be activated. Following activation, the configuration interface can remain activated for a certain period of time to receive the flight-related security data. It is conceivable that the configuration interface of the access point is only activated for a certain period of time, e.g., only for a period necessary for the receipt of the flight-related security data.

According to an exemplary embodiment, the configuration interface can be deactivated following receipt of the flight-related security data. It is guaranteed in this way that the configuration interface is only activated for as long as necessary, such as, e.g., only for so long until the receipt of the flight-related security data is complete. This further increases the reliability and security. According to a second exemplary embodiment, which can be implemented independently from or in combination with the first exemplary embodiment, the configuration interface can be deactivated on expiry of a predetermined time span. It is guaranteed by this that the configuration interface remains activated for no longer than a maximum time. This further increases the reliability and security.

Following receipt of the flight-related security data, a normal mode can further be activated. It is conceivable, for example, that the normal mode is activated after the configuration interface was deactivated and the access point has consequently exited the configuration mode. In the normal mode, the access of authenticated mobile terminals is possible. This means that following authentication and if applicable authorization of the preconfigured mobile terminals, the mobile terminals authenticated and if applicable authorized for certain control functions can access the access point in normal mode, i.e., communicate with this and send control commands, for example, as well as receiving messages and indications.

According to a second aspect, a method is provided for preparing the configuration of security settings of an access point arranged on board an aircraft for the authentication of mobile terminals. The method comprises receipt of flight-related security data at a mobile terminal from a security data server. The method further comprises forwarding of the flight-related security data to the access point, in order to facilitate a configuration of security settings of the access point based on the flight-related security data so that automatic authentication of mobile terminals for access to the access point is possible.

The method according to the second aspect relates to steps which are carried out in the mobile terminal of the master user or from the perspective of the mobile terminal of the master user.

The mobile terminal can receive the flight-related security data from the security data server via an at least partially wireless connection, such as a mobile radio network.

The method can further comprise requesting of the flight-related security data by the mobile terminal from a security data server. In addition and/or alternatively, the method can comprise notification of the mobile terminal by the security data server to request or pick up the flight-related security data.

The method can further comprise reading out or production of the flight-related security data by the mobile terminal, e.g., by the mobile master terminal, from a source of the flight-related security data deviating from the security data server. The security data read out or produced in this way can be stored in the mobile terminal. The flight-related security data read out or produced in such a way can subsequently be transmitted to the access point to facilitate the configuration of the security settings of the access point for access to the access point based on the flight-related security data. It can be guaranteed in this way that the access point can continue to be used on board the aircraft, even it was reset or had to be reset due to deletion of the flight-related security data originally received, for example. In addition, it can be guaranteed thus that if an original transmission of the security data to the mobile terminal and/or mobile terminals was not possible (and ultimately thus not necessarily possible to the access point either), the flight-related security data can be produced or read out later and made available both at the access point and at the mobile normal terminals for configuration. The security data can be produced in different ways. For example, the security data can be produced by a privileged mobile terminal, e.g., the mobile master terminal and distributed to the access point as well as the mobile normal terminals. The distribution of the security data to the mobile terminals by means of Quick Response (QR) tags/QR codes or NFC (Near Field Communication) tags is cited here purely as an example.

According to a third aspect, a method is provided for configuring security settings of an access point arranged on board an aircraft for the authentication of mobile terminals. The method comprises receipt of flight-related security data on a mobile terminal from a security data server. The method further comprises forwarding of the flight-related security data to the access point. The method further comprises receipt of the flight-related security data at the access point from the mobile terminal via a configuration interface of the access point. The method further comprises a configuration of security settings of the access point in a configuration mode based on the flight-related security data so that automatic authentication of the preconfigured mobile terminals for access to the access point is possible.

The method according to the third aspect relates to steps, which are executed by an interaction of the mobile terminal of the master user, the access point and the preconfigured mobile terminals or are carried out from their perspective.

The method can further comprise automatic authentication of the preconfigured mobile terminals that are located in the service area of the access point. The method can further comprise an access of the authenticated mobile terminals to the access point.

The method can further comprise control of cabin functions of the aircraft by means of the authenticated mobile terminals. The control of light, air-conditioning and audio functions on board the aircraft as well as the control of text notifications, cabin telephony and in-flight entertainment systems generally are cited at this point purely by way of example.

According to a fourth aspect, a computer program is provided that, when it is loaded in a computer or processor or runs on a computer or processor, causes the computer or processor to execute a method described herein. The computer program can be stored on a computer-readable program storage medium or be downloadable as a signal. The computer program can be manifested, for example, in the form of an application (app), which can be executed and runs on a mobile terminal described herein.

According to a fifth aspect, an access point is provided. The security settings of the access point are configurable for the authentication of mobile terminals located on board an aircraft. The access point comprises a configuration interface and a configuration component. The configuration interface is configured to receive flight-related security data from a mobile terminal. The configuration component is adapted to configure security settings of the access point in a configuration mode so that automatic authentication of preconfigured mobile terminals for access to the access point is possible.

The access point can be installed on board an aircraft. It can be connected to cabin management systems (CMS) of the aircraft, for example, and be able to communicate with components and units of the CMS, such as, e.g., transmit control commands to these. A digital CMS can be installed in aircraft. It usually controls the functions in the cabin and shows cabin parameters for passengers and crew. These include, among other things, the cabin lighting, cockpit/cabin announcements, door closure indication, emergency signals, no-smoking/fasten seat belt signs, smoke alarms, cabin temperature, water/waste tanks and various other cabin functions. The CMS can comprise one or more central computers, one or more devices with man-machine interface such as displays, buttons and indicator lamps as well as a data network for data transmission between the components in the cabin. The CMS can be connected to additional distributed control devices. These can comprise, for example, interface devices and devices connected thereto with a display, by means of which different cabin functions can be controlled (for example, the cabin temperature) or text messages can be displayed (e.g. for passenger calls, interphone calls or warnings). The access point can connect to one or more of the components or units so that one or more cabin functions can be controlled. It can be stated purely by way of example at this point that the access point is integrated into an interface device or can be connected to the interface device. An interface device can in this case be a device of the cabin management system, which serves as a gateway between the cabin management data backbone and the devices connected thereto, such as the text display, operating consoles, interphone and others.

All method features described previously with regard to the method according to the first aspect are realizable in the access point, for example in the configuration interface, the configuration component or in other components and units of the access point, such as a data processing unit.

According to a sixth aspect, a mobile terminal is provided for preparing the configuration of security settings of an access point arranged on board an aircraft for the authentication of mobile terminals. The mobile terminal comprises a receiving component and a transmitting component. The receiving component is configured to receive flight-related security data from a security data server. The transmitting component is configured to forward the flight-related security data to the access point, in order to facilitate a configuring of security settings of the access point based on the flight-related security data so that automatic authentication of preconfigured mobile terminals for access to the access point is possible.

Furthermore, all features described with regard to the method according to the second aspect can be realized in suitable components and units of the mobile terminal, such as the receiving component, the transmitting component or other components or units, such as a data processing unit.

According to a seventh aspect, a system is provided comprising the access point according to the fifth aspect and at least one mobile terminal according to the sixth aspect. It is noted here purely as an example that the mobile terminal and/or the preconfigured mobile terminals can be a mobile phone, a mobile computer (laptop, notebook), a tablet computer or also a portable wearable device, such as so-called smart glasses or smart watches.

According to an eighth aspect, an aircraft is provided comprising the access point according to the fifth aspect or the system according to the seventh aspect.

### BRIEF DESCRIPTION OF THE DRAWINGS

The present disclosure is to be explained further with reference to figures. These figures show schematically:

FIG. 1 a shows schematic representation of an exemplary embodiment of an access point that can be deployed on board an aircraft;

FIG. 2 shows a schematic representation of an exemplary embodiment of a mobile terminal for preparing the configuration of the access point from FIG. 1;

FIG. 3a shows a first phase for configuration of the access point from FIG. 1;

FIG. 3b shows a second phase for configuration of the access point from FIG. 1;

FIG. 3c shows a third phase for configuration of the access point from FIG. 1;

FIG. 4 shows a flow chart, which summarizes the three phases from FIGS. 3a to 3c;

FIG. 5a shows a first phase for configuration of an access point from the prior art; and

FIG. 5b shows a second phase for configuration of an access point from the prior art.

### DETAILED DESCRIPTION OF THE PREFERRED EMBODIMENTS

In the following, without being restricted to these, specific details are explained to supply a complete understanding of the present invention. However, it is clear to a person skilled in the art that the present invention can be used in other exemplary embodiments that can diverge from the details set out below. For example, the present invention is described in the following mostly with regard to the configuration of security settings. However, the principles described herein are equally applicable to the updating of this security data.

It is clear to the person skilled in the art that the explanations set out below can be implemented using hardware circuits, software means or a combination of these. The software means can be associated with programmed microprocessors or a general computer, an ASIC (Application Specific Integrated Circuit) and/or DSPs (Digital Signal Processors). The software means can be realized as an application or in an application (APP), which runs on a terminal. It is also clear that even if the following details are described with regard to a method, these details can also be realized in a suitable device unit, a computer processor and a memory connected to a processor, wherein the memory is provided with one or more programs, which carry out the method when they are executed by the processor.

The enclosed figures serve purely for the purposes of clarifying exemplary embodiments. They are not true to scale and are only intended to reflect the general concept of the invention as an example. For example, features that are contained in the figures should by no means be considered as a necessary constituent.

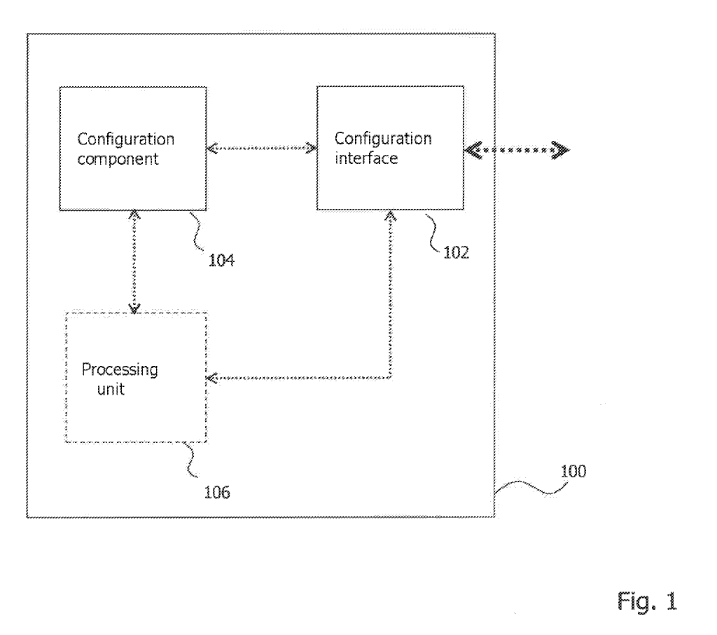

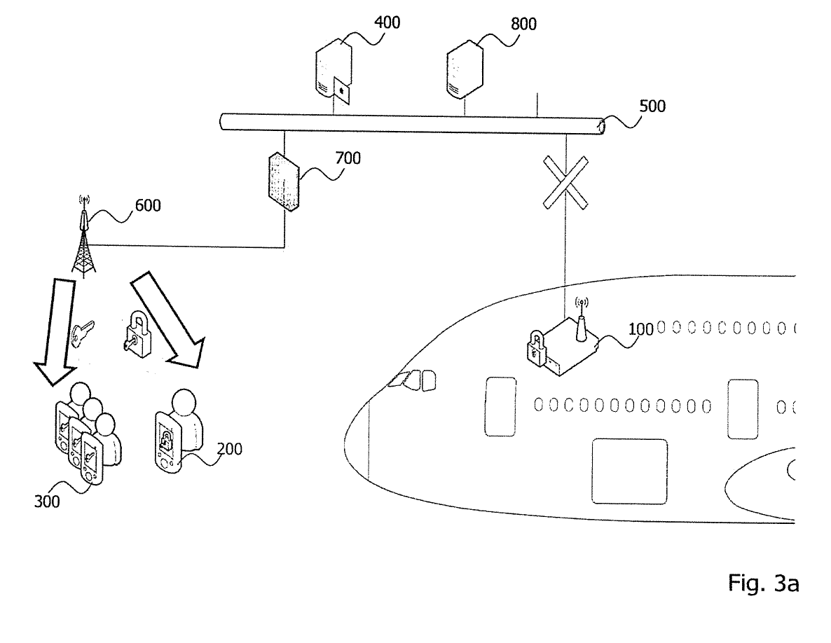

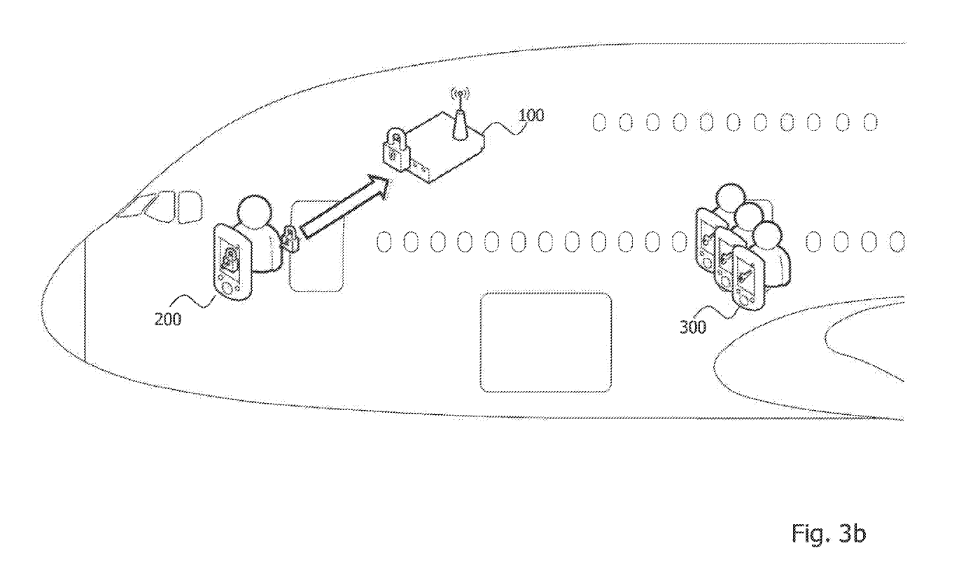

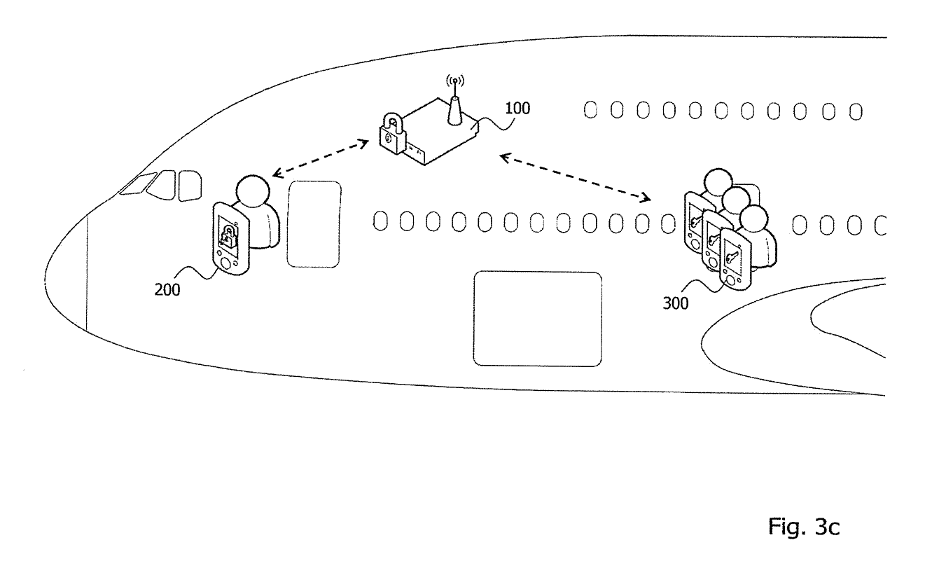

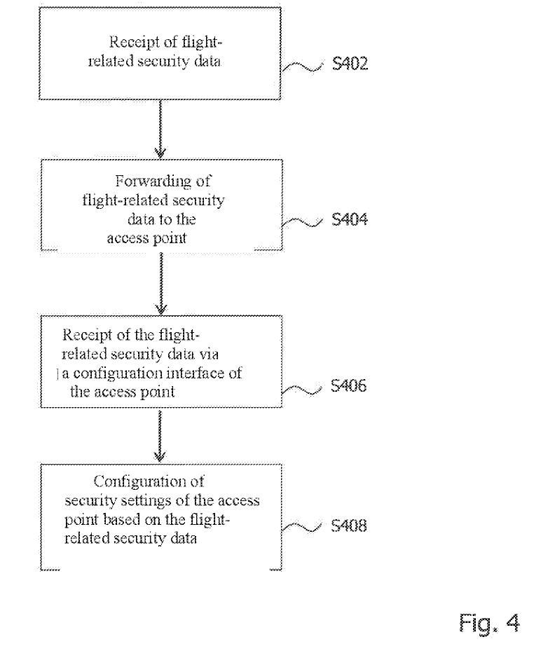

FIG. 1 shows a block diagram of an exemplary embodiment of an access point 100 that can be used and installed on board an aircraft. The access point 100 has a configuration interface 102 and a configuration component 104. Furthermore, the access point 100 can optionally have a processing unit 106. The configuration component 104 is shown separately from the processing unit 106 in FIG. 1 purely by way of example. However, the configuration component 104 can alternatively also be part of the processing unit 106. Further details of the access point 100 are described in regard to FIGS. 3a to 3c and 4.

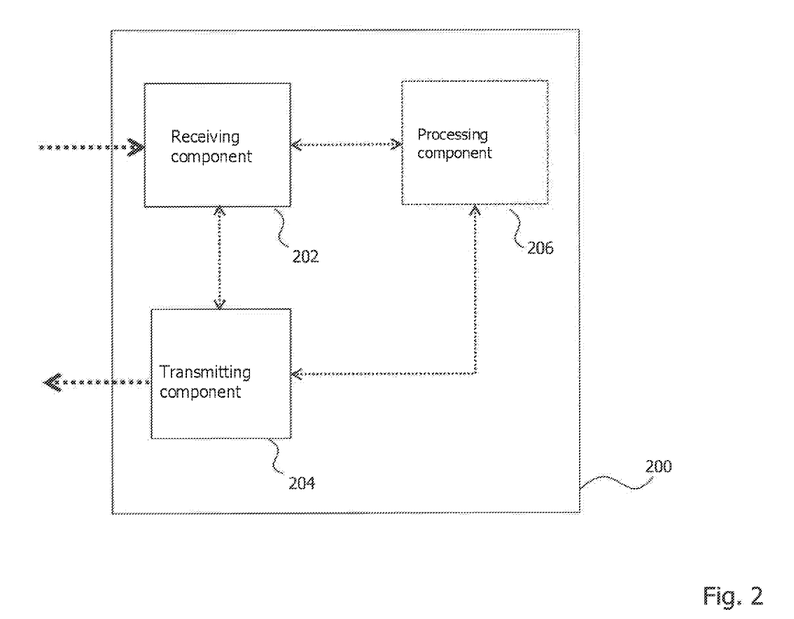

FIG. 2 shows an exemplary embodiment of a mobile terminal 200. The mobile terminal comprises a receiving component 202 and a transmitting component 204. The mobile terminal 200 can also optionally comprise a processing component 206. Details of the mobile terminal 200 are now explained in relation to FIGS. 3a to 3c and 4.

Before a scheduled flight, a so-called master user with the mobile terminal 200 is not located on board the aircraft, for example not in the aircraft cabin, i.e., not in the service area of the access point 100. The mobile terminal 200 can connect, e.g., by means of a software package running on the mobile terminal 200 to a security data server 400. Purely as an example, this connection takes place according to FIG. 3a via a secure data network 500, a firewall 700 and a mobile radio network 600. Other types of connection are possible. Furthermore, a remote connection server 800 is shown in FIG. 3a. As can further be recognized in FIG. 3a, no permanent connection exists between the access point 100 on the one hand and the network 500, the security data server 400 and the remote connection server 800 on the other. Several mobile terminals 300 are also to be recognized in FIG. 3a, which are not assigned to the master user. However, they can be designed in principle exactly the same as or similar to the mobile terminal 200.

The master user, e.g., the purser, instead connects to the security data server 400 in accordance with the example in FIG. 3a by means of the mobile terminal 200 via a mobile radio network 600. In the course of this it is checked whether security data and/or updates of security data are available for the mobile terminal 200. This security data is specifically for the next flight to be undertaken by the master user and is used for configuration of the access point 100 so that access to the access point 100 and thus to an onboard network on board the aircraft is guaranteed. If new or updated security data is available, the mobile terminal 200 retrieves this security data or, generally speaking, receives this security data from the security data server 400. In this respect, the mobile terminal 200 can operate as a type of security client, so to speak. In addition, the mobile terminals 300 receive at least a portion of the security data from the security data server 400. The mobile terminals 300 are carried not by the master user but by normal users, such as other members of the aircrew. The mobile terminals 300 receive at least a portion of the security data, which guarantees that the mobile terminals can later be authenticated by the access point 100. This portion of the security data can be the network name and the network key.

The connection to the security data server 400 can be triggered (activated), for example, by the user of the mobile terminal 200 or by the mobile terminal 200 itself, for example by software running on the mobile terminal, such as the application. In addition or alternatively, the connection can be triggered (activated) by networks/systems available on the ground, such as by an interaction of security data server 400 and mobile radio network 600. In the case of activation by the security data server 400, this can trigger the connection, for example, by means of a so-called data push via the mobile radio network 600 or similar.

As soon as the security data for the next flight has been checked/verified on the mobile terminal 200 or updated successfully on the mobile terminal 200, the master user can enter the cabin of the aircraft to configure the access point 100 by means of the security data. This is illustrated in FIG. 3b. Then the access point 100 is triggered (activated) to change from a normal mode to a configuration mode. The master user can initiate the transmission of a confidential signal for triggering. This can happen, for example, in that the master user actuates an actuation element in the aircraft, such as a certain button or a certain key or an operating element on the cabin management system or components of the cabin management system. This actuation can activate the trigger signal accordingly, which is transmitted, e.g., hard-wired to the access point 100. Alternatively, a transmission can take place via so-called out-of-band systems. At any rate, by transmission of the confidential signal the access point 100, and only the access point 100, is notified that it should change to the configuration mode. Other devices cannot gain any knowledge of this, as the confidential signal is transmitted via a secure communications channel Following receipt of the signal, the access point 100 changes over into configuration mode. Following the successful transition to the configuration mode, the access point 100 activates a special configuration interface 102. The special attributes of this configuration interface, for example authentication rights, protocols or similar, are known only to the mobile terminal 200 of the master user, for example because these were transmitted as part of the security data that was only communicated to the mobile terminal 200 of the master user. Accordingly, only the mobile terminal 200 of the master user can connect to the access point 100 via the configuration interface 102. For other devices connection via the configuration interface 102 is impossible. Following successful connection, an operation can be executed corresponding to the rights of the mobile terminal 200 to determine the security settings in the access point 100. To do this, the mobile terminal 200 transmits the security data via the configuration interface 102 to the access point 100. In addition, software parameterization or a software update can be carried out at the access point 100.

As mentioned, the connected mobile terminal 200 of the master user will now automatically transmit the correct security data to the access point 100. This security data can be, for example, the network name (e.g. the service set identifier (SSID)), the network key, and/or information about valid/invalid client certificates. It can be verified by the latter, for example, whether only authorized mobile terminals 200, 300 really wish to connect to the access point 100. Furthermore, information can be contained in the security data by means of which authorizations of the mobile terminals 200, 300 or of the users of the mobile terminals 200, 300 can be verified by the access point 100. This can be described as authorization by the access point 100. For example, the access point 100 can ascertain with reference to the security data whether the user of a mobile terminal 200 is authorized to control all or just a portion of the cabin functions, such as, e.g., only the cabin light etc.

As soon as the security data for the next flight has been successfully received at the access point 100 from the mobile terminal 200 of the master user, the access point 100 automatically deactivates the configuration interface 102. The access point 100 accordingly transfers from configuration mode to normal mode. As additional protection it can be provided that the configuration interface 102 is deactivated on expiry of a certain time span, i.e., the access point 100 transfers from the configuration mode to normal mode. Based on the security data received the access point can configure or update its security settings.

In normal mode, the new or updated security settings are present in the access point 100 so that mobile terminals 300 of normal users, for example normal flight attendants, can connect automatically to the network via the access point 100 as soon as they enter its service area and have been authenticated by the access point 100, as shown in FIG. 3c. This means that in normal mode not only the mobile terminal 200 but also the mobile terminals 300 can connect to the access point 100 if they are authorized to do this. For automatic access to the access point 100, the mobile terminals 300 must be located in the service area of the access point 100 and be authenticated as authorized by the access point 100. The access point 100 can undertake the authentication with reference to the preconfiguration of the mobile terminals 300. The preconfiguration can be security settings, for example, which are preset or can be produced by means of a special app or special software. It is conceivable that the access point 100 and the mobile terminals transmit or exchange information unilaterally or reciprocally, such as at least portions of the security data, so that the access point 100 can check the access authorization of the mobile terminals 300.

In FIG. 4, the details described in regard to FIGS. 3a to 3c are summarized. First a mobile terminal 200 receives flight-related security data from a security data server 400 (step S402). Then the mobile terminal 200 forwards the flight-related security data to the access point 100 (step S404). Then the access point 100 receives the flight-related security data from the mobile terminal 200 via a configuration interface 102 of the access point 100 (step 406). Finally, the access point 100 configures its security settings in a configuration mode based on the flight-related security data. This enables automatic authentication of mobile terminals 200, 300 to be possible for access to the access point 100 (step S408).

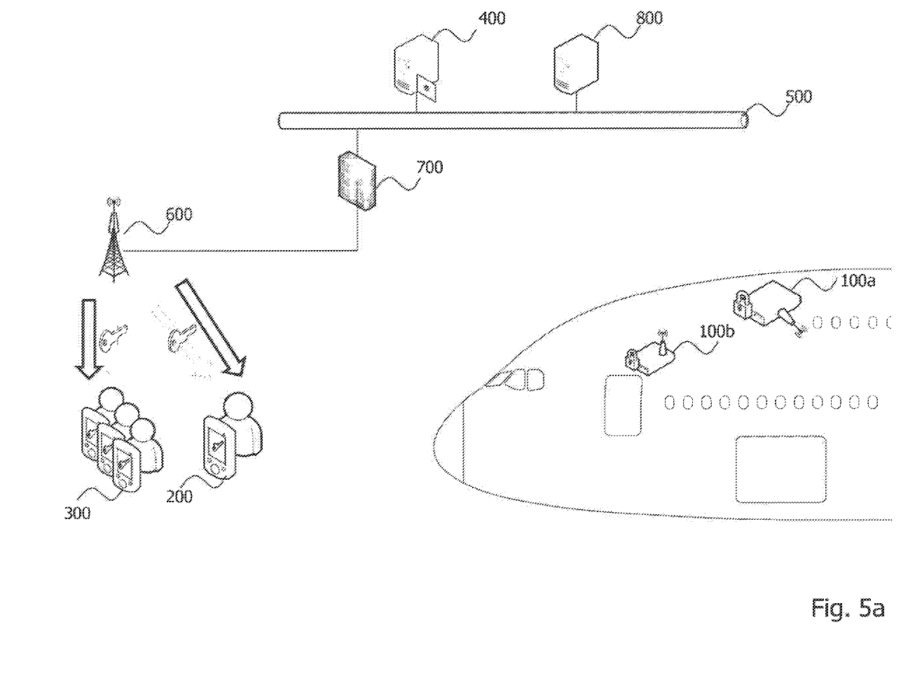

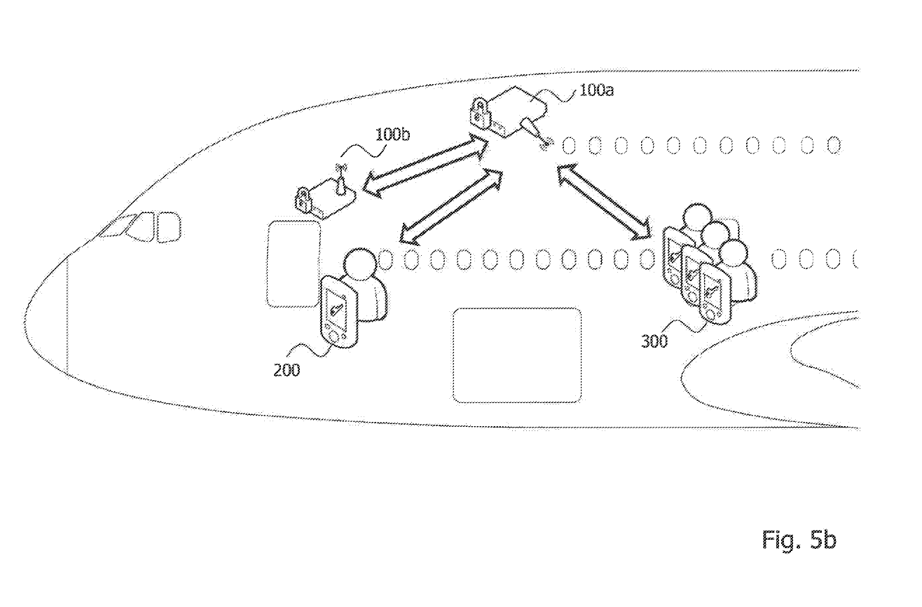

In relation to FIGS. 5a and 5b a case is now explained in which an access point 100a is already preinstalled in an aircraft and not exchanged and is to be replaced by the access point 100. In this case an additional control unit 100b is provided in the aircraft. The access point 100a assumes the role of a Wi-Fi access point 100a in this case and the control unit 100b assumes the function of control of commands received, such as the control of cabin functions.

As is to be recognized from FIG. 5a, in this case the mobile terminal 200 of the master user and the mobile terminals 300 of the normal users receive flight-related security data from the security data server 400 as already described in FIG. 3a. It is conceivable that the mobile terminals 200 and the mobile terminals 300 receive identical security data. The mobile terminals 200, 300, which are located in the service area of the access point 100a, can now gain access to the access point 100a as was described in relation to FIG. 3c. However, the access point 100a does not execute the control commands received in the example in FIG. 5b. Instead it forwards the control commands received to the control unit 100b, which understands the control commands and can process them further accordingly. The control unit 100b controls the respective cabin functions accordingly. Simple retrofitting of aircraft for secure control by mobile terminals is facilitated by the procedure described in relation to FIGS. 3a and 3b.

With the aid of the invention an authentication system, parts thereof and corresponding methods are provided, which are at least as secure as the prior art of the Enterprise Wi-Fi network security solutions. Furthermore, at least a similar user friendliness is achieved. However, in contrast to the prior art it is not necessary for the access points 100 to be connected directly to the security data server 400 via a backbone network.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for configuring security settings of an access point arranged on board an aircraft for the authentication of mobile terminals, wherein the method comprises:
receiving flight-related security data from a mobile terminal via a configuration interface of the access point; and
configuring security settings of the access point in a configuration mode based on the flight-related security data so that automatic authentication of preconfigured mobile terminals for access to the access point is possible.

2. The method according to claim 1, wherein the method further comprises at least one of:
automatically authenticating the preconfigured mobile terminals, which are located in the service area of the access point, for access to the access point; or
automatically authorizing the preconfigured mobile terminals, which are located in the service area of the access point, for access to the access point.

3. The method according to claim 1, wherein the method further comprises:
receipt of a trigger signal via a secure communications channel; and
activation of the configuration interface following receipt of the trigger signal.

4. The method according to claim 1, wherein the method further comprises:
deactivation of the configuration interface following receipt of the flight-related security settings or on expiry of a predetermined time span.

5. The method according to claim 1, wherein the method further comprises:
activating a normal mode, in which the access to the access point is possible by authenticated mobile terminals following receipt of the flight-related security data.

6. A method for preparing the configuration of security settings of an access point arranged on board an aircraft for the authentication of mobile terminals, wherein the method comprises:
receiving flight-related security data on a mobile terminal from a security data server; and
forwarding the flight-related security data to the access point, in order to facilitate a configuration of security settings of the access point based on the flight-related security data, so that automatic authentication of preconfigured mobile terminals for access to the access point is possible.

7. The method according to claim 6, wherein the method comprises at least one of:
requesting the flight-related security data by the mobile terminal from a security data server; or
notifying the mobile terminal by the security data server to request the flight-related security data.

8. The method according to claim 6, wherein the method further comprises:
reading out or producing the flight-related security data by the mobile terminal from a source of the flight-related security data deviating from the security data server;
storing the flight-related security data on the mobile terminal; and
transmitting the flight-related security data to the access point in order to facilitate the configuration of the security settings of the access point for access to the access point based on the flight-related security data.

9. A method for configuring security settings of an access point arranged on board an aircraft for the authentication of mobile terminals, wherein the method comprises:
receiving flight-related security data on a mobile terminal from a security data server;
forwarding the flight-related security data to the access point;
receiving the flight-related security data from the mobile terminal via a configuration interface of the access point; and
configuring security settings of the access point in a configuration mode based on the flight-related security data so that automatic authentication of preconfigured mobile terminals for access to the access point is possible.

10. The method according to claim 9, wherein the method further comprises at least one of:
automatically authenticating mobile terminals, which are located in the service area of the access point; or
providing accesses of the authenticated mobile terminals to the access point.

11. The method according to claim 10, wherein the method further comprises:
controlling cabin functions of the aircraft via the authenticated mobile terminals.

12. A computer program product stored on a non-transitory medium comprising executable instruction which, when executed by a processor unit of a computing device, configure the computing device to perform the method according to claim 1.

13. An access point, the security settings of which are configurable for the authentication of mobile terminals located on board an aircraft, wherein the access point comprises:
a configuration interface, which is configured to receive flight-related security data from a mobile terminal; and
a configuration component, which is adapted to configure security settings of the access point in a configuration mode so that automatic authentication of preconfigured mobile terminals for access to the access point is possible.

14. A mobile terminal for preparing the configuration of security settings of an access point arranged on board an aircraft for the authentication of mobile terminals, wherein the mobile terminal comprises:
a receiving component, which is configured to receive flight-related security data from a security data server; and
a transmitting component, which is configured to forward the flight-related security data to the access point in order to facilitate a configuring of security settings of the access point based on the flight-related security data so that automatic authentication of mobile terminals for access to the access point is possible.

15. A system comprising:
an access point, the security settings of which are configurable for the authentication of mobile terminals located on board an aircraft, wherein the access point comprises:
a configuration interface, which is configured to receive flight-related security data from a mobile terminal; and
a configuration component, which is adapted to configure security settings of the access point in a configuration mode so that automatic authentication of preconfigured mobile terminals for access to the access point is possible, and
at least one mobile terminal according to claim 14.
